(19) United States
(12) Patent Application Publication
(10) Pub. No.: US 2002/0104710 A1
(43) Pub. Date: Aug. 8, 2002

(54) Scaffold safety net

(76) Inventors: Michael W. Thompson, Woodstock, GA (US); Jerry S. Adams, Hammond, LA (US)

Correspondence Address: Greensfelder, Hemker & Gale, P.C., Intellectual Property Group, Suite 2000, 10 South Broadway, St. Louis, MO, 63102, US

(21) Appl. No.: 10/028,878

(22) Filed: Dec. 20, 2001

Related U.S. Application Data
(60) Provisional application No. 60/258,413, filed on Dec. 27, 2000.

(51) Int. Cl. A62B 1/22

(52) U.S. Cl. 182/138

(57) ABSTRACT

A mobile safety net for scaffolding comprising an elongated border member defining a closed interior area, a mesh structure defining a grid bounded by the border member along the entire length of the border member, and a plurality of connecting devices connected along the periphery of the border member for securing and releasing the mobile safety net to and from the scaffolding.

### CROSS-REFERENCE TO RELATED APPLICATIONS

This application is based upon Provisional Patent Application, Ser. No. 60/258,413, entitled “Scaffold Safety Net”, filed Dec. 27, 2000, the contents of which are incorporated herein by reference in their entirety and continued preservation of which is requested.

### BACKGROUND OF THE INVENTION

1. Field of the Invention

The present invention relates to nets, and more particularly to safety nets. More specifically, the present invention relates to a scaffold safety net for use while scaffolding is being constructed or disassembled.

2. Prior Art

Scaffolding is commonly used in construction and in structural maintenance industries and typically comprises a number of scaffolds which define adjacently formed open box structures, referred to as bays or modules, that proceed in both horizontal and vertical directions as required to meet a desired task. The floor dimensions of a standard scaffold module usually measures eight feet by eight feet, although different floor dimensions may be used. As known in the art, modules may extend to great heights above the ground, thereby raising safety concerns for those persons working on the scaffolding. It is not surprising that approximately twenty percent of construction falls involve scaffolding. In addition to the safety of workers on scaffolding, there is also a concern for the safety of those persons on the ground from objects falling off the scaffolding.

Conventionally, the method of protecting scaffold workers from falling is through the use of harnesses tethered to the scaffolding. Unfortunately, tethered harnesses have been known to cause death by asphyxiation due to tightening of the harness about the ribcage of the worker while suspended in mid-air. A secondary means of providing protection would be to install safety nets along the floor of scaffold modules while scaffolding is being constructed or disassembled, thereby greatly reducing the hazards associated with harnesses. However, the current practice is to deploy safety nets that only extend outwardly from the face of the building, or are used to cover holes at ground level. This conventional thinking, which is promulgated in current Occupational Safety & Health Administration (OSHA) regulations, is that nets cannot be practically used with scaffolds. As recited in the OSHA regulations, “[s]afety nets shall be provided when workplaces are more than 25 feet above the ground or water surface, or other surfaces where the use of ladders, scaffolds, catch platforms, temporary floors, safety lines, or safety belts is impractical.” 29 CFR 1926.105(a) (1995)

Therefore, there appears a need in the art for a scaffold safety net for use while scaffolding is being constructed or disassembled.

### OBJECTS AND SUMMARY OF THE INVENTION

The primary object of the present invention is to provide a scaffold safety net for use while scaffolding is being constructed or disassembled.

Another object of the present invention is to provide a scaffold safety net that may be quickly moved between adjacent scaffold modules.

A further object of the present invention is to provide a scaffold safety net that complies with all industry and regulatory standards.

Another further object of the present invention is to provide a scaffold safety net that is inexpensive to manufacture.

These and other objects of the present invention are realized in the preferred embodiment of the present invention, described by way of example and not by way of limitation, which provides for a novel scaffold safety net.

In brief summary, the present invention overcomes and substantially alleviates the deficiencies in the prior art by providing a mobile safety net for multi-floor modular construction structures which comprises a border member which encloses a mesh structure. The mesh structure has first and second elongated mesh members which interconnect at predetermined intervals. Further, the mesh structure is adapted to securely connect to the border member along the entire length of the border member. Finally, a plurality of connecting devices extend from the periphery of the border member for securing the mobile safety net to the modular construction structure.

Additional objects, advantages and novel features of the invention will be set forth in the description which follows, and will become apparent to those skilled in the art upon examination of the following more detailed description and drawings in which like elements of the invention are similarly numbered throughout.

### BRIEF DESCRIPTION OF THE DRAWINGS

FIG. 1 is a plan view of a scaffold safety net in an installed condition according to the present invention;

FIG. 2 is an enlarged partial plan view of the connecting device used in FIG. 1 according to the present invention;

FIG. 3 is an enlarged partial plan view of an alternate embodiment of a connecting device used in FIG. 1 according to the present invention;

FIG. 4 is an enlarged partial plan view of the connecting device used in FIG. 1 secured to structure according to the present invention;

FIG. 5 is an enlarged partial plan view of an alternate embodiment of the connecting device used in FIG. 1 secured to structure according to the present invention;

FIG. 6A is a perspective view of the scaffold safety net installed in a scaffold module according to the present invention;

FIG. 6B is a perspective view of the scaffold safety net being moved between adjacent scaffold modules according to the present invention;

FIG. 6C is a perspective view of the scaffold safety net installed in an adjacent scaffold module according to the present invention; and

FIG. 7 is a perspective view of the scaffold safety net installed in a scaffold module for installation in an adjacent horizontal scaffold module according to the present invention.

### DETAILED DESCRIPTION OF THE INVENTION

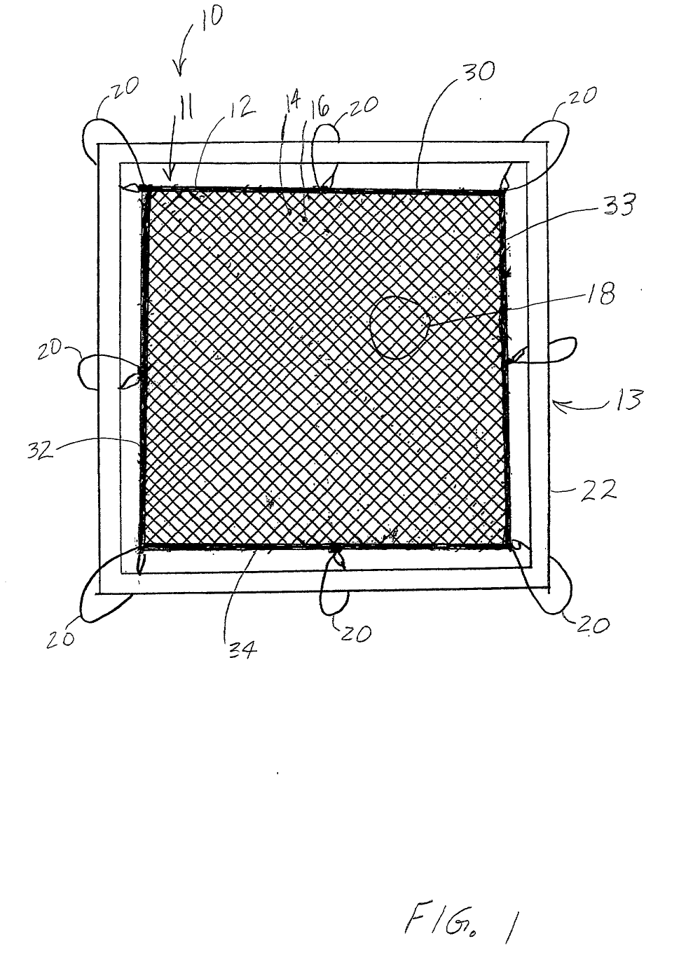

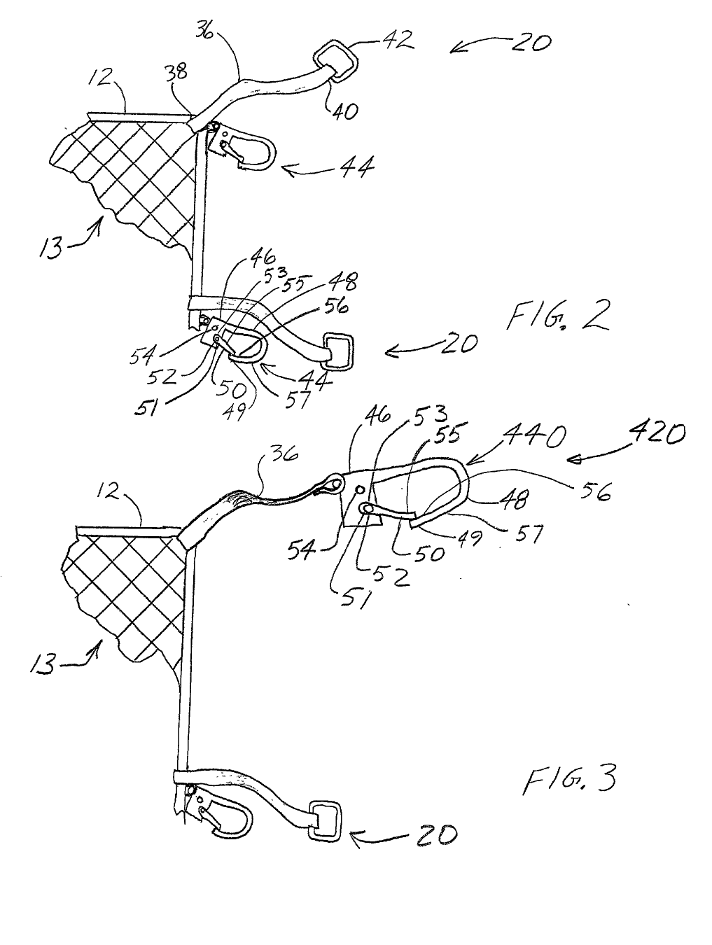

Referring to the drawings, the preferred embodiment of the scaffold safety net of the present invention is illustrated and generally indicated as 10 in FIG. 1. Referring to FIG. 1, scaffold safety net 10 is used with a scaffold structure 22 and comprises a mesh structure 13 bounded by a border structure 11 which preferably is a single border member 12 that includes a top side 30, a bottom side 34, and opposing first and second sides 32 and 33. Mesh structure 13 comprises first and second elongated mesh members 14 and 16 which interconnect in a pattern to define a grid 18. Referring to FIG. 2, a plurality of connecting devices 20 having double locking snap hooks 44 are provided along the periphery of border member 12 for looping around and securely engaging scaffold structure 22 to support scaffold safety net 10 thereto. To sufficiently distribute forces imposed on scaffold safety net 10 from falling objects, as well as to minimize the opportunity for the falling object to escape the net 10 by slipping between the sides of the net and scaffold structure 22, connecting devices 20 are preferably supplied along the corners, or juncture of multiple lengths of border member 12, and the mid-spans of each side 30, 32, 33, 34 for a total of at least eight connecting devices 20 being used to secure scaffold safety net 10 to scaffold structure 22.

Referring to FIGS. 1 and 2, connecting device 20 comprises a flexible member 36, preferably a strap, having a proximal end 38 securely attached to border member 12 and a distal end 40 securely attached to eyelet 42 for engaging a snap hook 44 after strap 36 has been looped around scaffold structure 22 (FIG. 1). Snap hook 44 is securely attached to border member 12 adjacent proximal end 38. As should be appreciated by one skilled in the art, one embodiment of snap hook 44 comprises a body 46 including a hook member 48 further having an inside surface 56 and an outside surface 57 that terminate in a tip 49 which passes through eyelet 42 for secure engagement therewith. To prevent eyelet 42 from inadvertently slipping off hook member 48, referred to as “roll out”, a tongue 50 is provided. As is shown, tongue 50 has a proximal end 53 and a distal end 55 with an aperture 51 formed in proximal end 53 for pivotally engaging a pin 52. An internal spring (not shown) urges tongue 50 to rotate about pin 52 until contacting inside surface 56 when snap hook 44 is placed in the closed position. An additional safety feature of snap hook 44 is a locking feature (not shown) to prevent inadvertent rotation of tongue 50 about pin 52 in a direction away from inside surface 56 which may open snap hook 44. Collectively, these safety features provide a fail-safe engagement with any element that is secured within snap hook 44. By depressing release button 54, the locking feature is overcome which permits distal end 55 of tongue 50 to rotate about pin 52 in a direction away from inside surface 56 when accompanied by a force sufficient to overcome the internal spring.

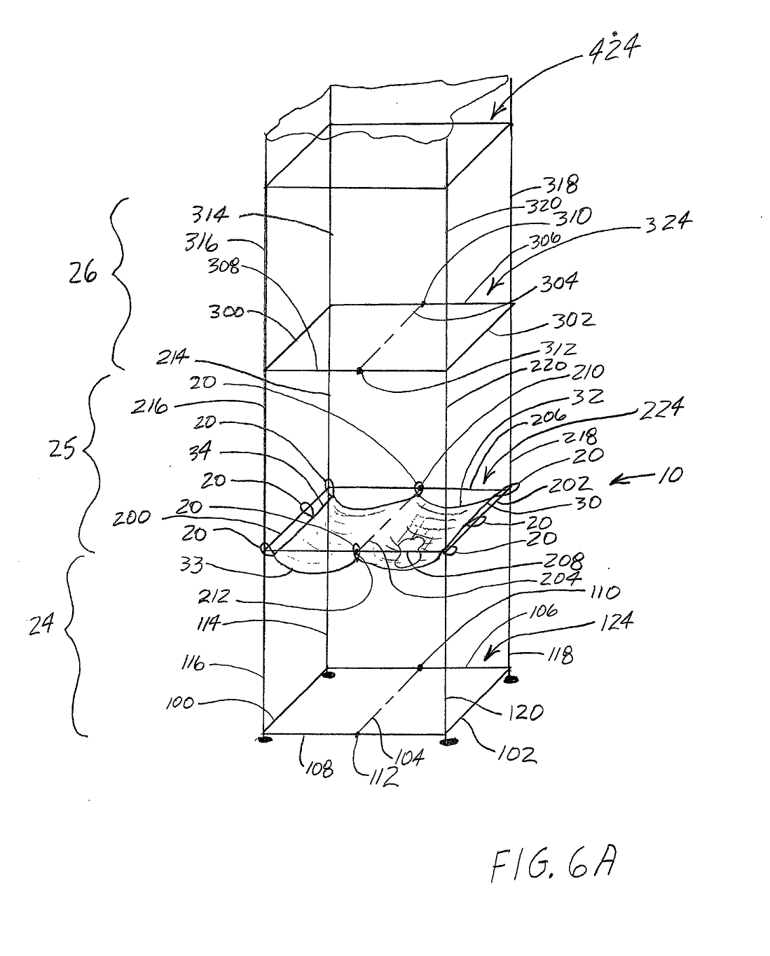

Referring to FIGS. 2 and 4, the operation of connecting device 20 is discussed. After guiding distal end 40 of strap 36 loopingly around scaffold structure 22 and bringing eyelet 42 into contact with tongue 50 of snap hook 44, depressing release button 54 permits tongue 50 to rotate about pin 52. By applying a sufficient force to eyelet 42 in a direction which overcomes the resistance of internal spring force in order to rotate tongue 50 about pin 52, distal end 55 of tongue 50 is forced to rotate away from inside surface 56 of hook member until the distance between distal end 55 and inside surface 56 is sufficient to permit eyelet 42 to slide over tip 49 and engage snap hook 44. Once eyelet slides past distal end 55, the internal spring forces applied to tongue 50 will rotate tongue 50 about pin 52, thereby moving distal end 55 of tongue 50 toward and into contact with inside surface 56 and providing secure engagement of eyelet 42 with snap hook 44. Further, by ensuring release button 54 is no longer depressed, rotation of tongue 50 is prevented, and eyelet 42 is safely secured with snap hook 44.

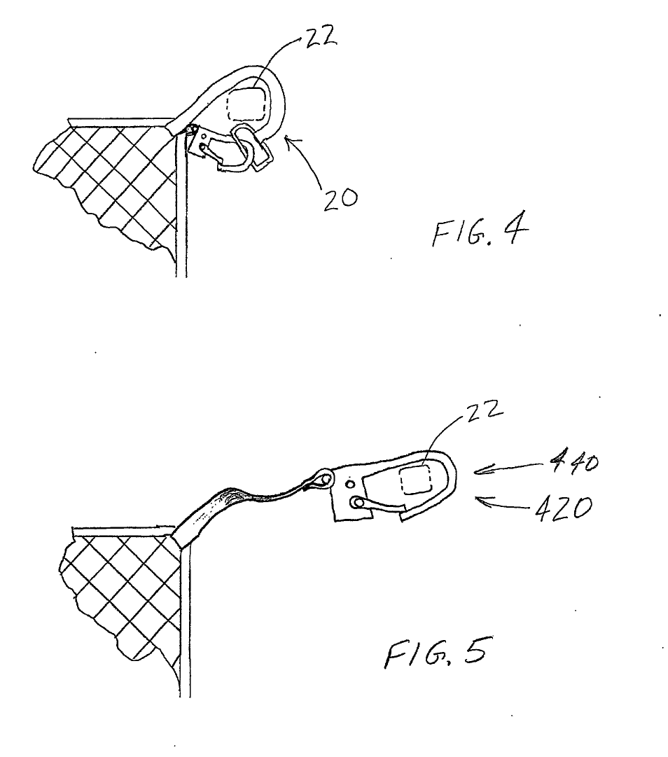

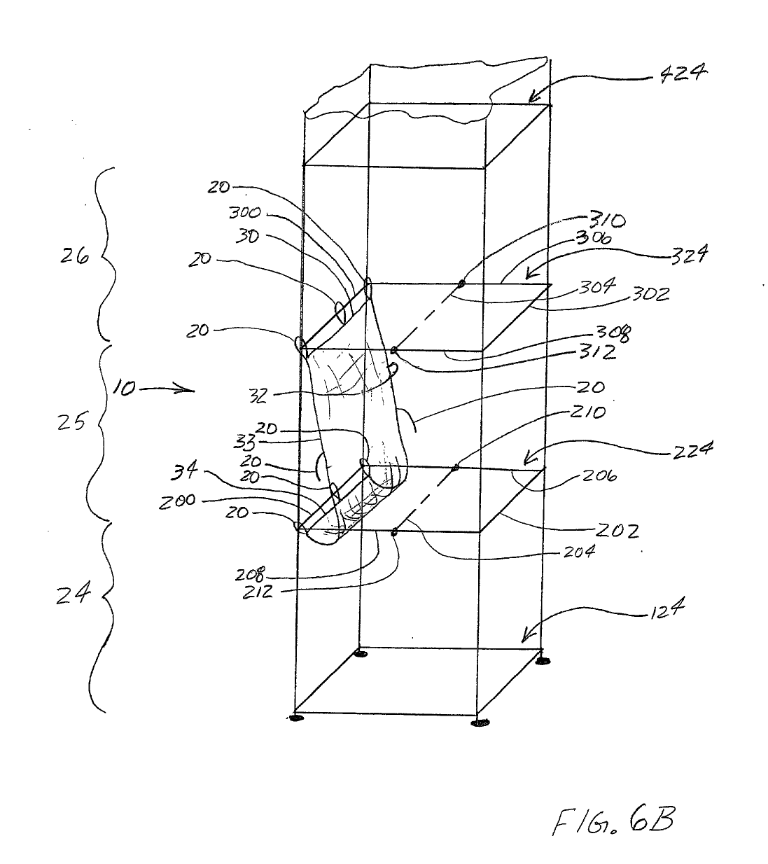

Referring to FIG. 3, an alternate embodiment of connecting device 420 is discussed. It is noted that snap hook 440 operates in the same manner as snap hook 44 with the only difference being that snap hook 440 has a much larger configuration. Referring to FIG. 5, snap hook 440 of connecting device 420 secures scaffold structure 22 in the manner previously described to engage eyelet 42. The present invention contemplates that the larger snap hook 440 can reduce installation/removal time by the user. Additionally, snap hook 440 may be installed with one hand which permits scaffold workers to maintain their grip on scaffold structure 22 with their other hand, which is especially desirable when working at great heights. The preferred installation procedure has scaffold workers installing corner connecting devices 20, 420 from beneath and installing mid-span connecting devices 20,420 from above after installing walking boards (not shown) across scaffold structure 22. Therefore, alternate connecting devices 420 are preferably installed at the corners and preferred connecting devices 20 may be installed at the mid-spans of safety device 10, although any suitable combination is felt to fall within the spirit and scope of the present invention.

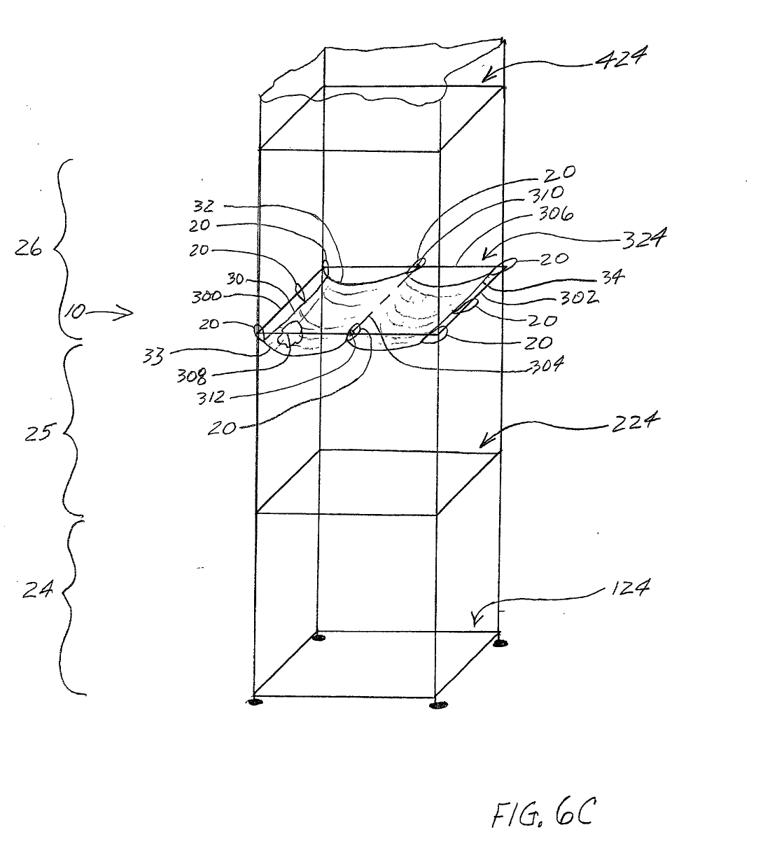

Referring to FIGS. 6A-6C, scaffold structure 22 comprises a first module 24, a second module 25, and a third module 26 which extend vertically with respect to each other. First module 24 includes a base periphery 124 defined by a lateral member 100, also referred to as an edge or a lateral edge, lateral edge 102, and opposing first and second edges 106 and 108. Base periphery 124 is formed by interconnecting the adjacent lateral members at their respective ends. The term lateral is the equivalent of horizontal for purposes of scaffold construction herein. Additionally, a mid line 104 is defined between lateral edge 100 and lateral edge 102 which intersects first edge 106 at first mid point 110 and second edge 108 at second mid point 112. Extending vertically from opposing ends of lateral edge 100 are first and second lateral supports 114 and 116, also referred to as lateral members or lateral support members, while extending vertically from opposing ends of lateral edge 102 are third and fourth lateral supports 118 and 120 which collectively support a base periphery 224 of second module 25. It should be appreciated that base peripheries 124 and 224, first and second supports 114 and 116 and third and fourth supports 118 and 120, respectively, define first module 24.

Positioned atop first module 24 is second module 25 having base periphery 224 defined by a lateral edge 200, a lateral edge 202, and opposing first and second edges 206 and 208. As further shown, a mid line 204 is defined between lateral edge 200 and lateral edge 202 which intersects first edge 206 at a first mid point 210 and second edge 208 at a second mid point 212. Extending vertically from opposing ends of lateral edge 200 are first and second lateral supports 214 and 216, while extending vertically from opposing ends of lateral edge 202 are third and fourth lateral supports 218 and 220 which collectively support a base periphery 324 of third module 26. It should be appreciated that base peripheries 224 and 324, first and second supports 214 and 216 and third and fourth supports 218 and 220, respectively, define second module 25.

Positioned atop second module 25 is third module 26 having a base periphery 324 defined by a lateral edge 300, a lateral edge 302, and opposing first and second edges 306 and 308. As further shown, a mid line 304 is defined between lateral edge 300 and lateral edge 302 which intersects first edge 306 at a first mid point 310 and second adjacent edge 308 at a second mid point 312. Extending vertically from opposing ends of lateral edge 300 are first and second lateral supports 314 and 316, while extending vertically from opposing ends of lateral member 302 are third and fourth lateral supports 318 and 320 which collectively support a base periphery 424 of a fourth module 27 (not shown). It should be appreciated that base peripheries 324 and 424, first and second supports 314 and 316 and third and fourth supports 318 and 320, respectively, define third module 26.

Referring specifically to FIG. 6A, scaffold safety net 10 is shown installed along base periphery 224 of second module 25. During installation, connecting devices 20 connected to top side 30 of scaffold safety net 10 are securely attached along lateral edge 202. Similarly, connecting devices 20 connected to opposing first and second sides 32 and 33 are then securely attached along first and second edges 206 and 208 at first and second mid points 210 and 212, respectively. Finally, connecting devices 20 connected to bottom side 34 are securely attached along lateral edge 200, thus securely attaching scaffold safety net 10 to scaffolding structure 22 along the entire base periphery 224 of second module 25. One skilled in the art can appreciate that sides 30, 32, 33, 34 may be attached to respective edges 200, 202, 206, 208 in any order without departing from the spirit and scope of the present invention.

Referring to FIGS. 6A-6C, the sequence of moving scaffold safety net 10 from base periphery to another base periphery shall now be discussed. To move scaffold safety net 10 to another base periphery, connecting devices 20 connected to top side 30 are disconnected from lateral edge 202. Connecting devices 20 connected to first and second sides 32 and 33 are then disconnected from first and second adjacent edges 206 and 208 at first and second mid points 210 and 212, respectively. As is illustrated on FIG. 6B, connecting devices connected to first side 30 are securely attached along lateral edge 300 of base periphery 324 of third module 26. By disconnecting connecting devices 20 connected to bottom side 34 from lateral edge 200, scaffold safety net 10 becomes separated from base periphery 224 of second module 25. Referring to FIG. 6C, by pivoting scaffold safety net 10 about lateral edge 300, connecting devices 20 connected to first and second sides 32 and 33 are securely attached along first and second edges 306 and 308, respectively, at first and second mid points 310 and 312. As further shown, connecting devices 20 connected to bottom side 34 are securely attached along lateral edge 302, thereby securing scaffold safety net 10 to scaffold structure 22 along base periphery 324 of third module 26. It should be apparent to one of skill in the art that scaffold safety net 10 can be quickly installed and removed by the user following this procedure.

The present invention further contemplates that after disconnecting top side 30 and opposing first and second sides 32 and 33 from the base periphery of any one module, bottom side 34 may also be disconnected from the base periphery of that module and attached to the base periphery of an adjacent module before likewise attaching opposing first and second sides 32 and 33 to the base periphery of that adjacent module. Alternatively, the method of attaching bottom side 34 and first and second sides 32 and 33 may be combined. In other words, at least one connecting device 20 connected to either first or second sides 32 and 33 may be attached followed by attaching at least one connecting device 20 connected to bottom side 34. Moreover, it is additionally contemplated that when the length of opposing first and second sides 32 and 33 is less than the parallel distance between lateral edges 200 and 300 (i.e., the distance between adjacent floor edges), it may be necessary to additionally disconnect connecting devices 20 connected to bottom side 34 from lateral edge 200, thereby totally disconnecting scaffold safety net 10 from scaffold structure 22.

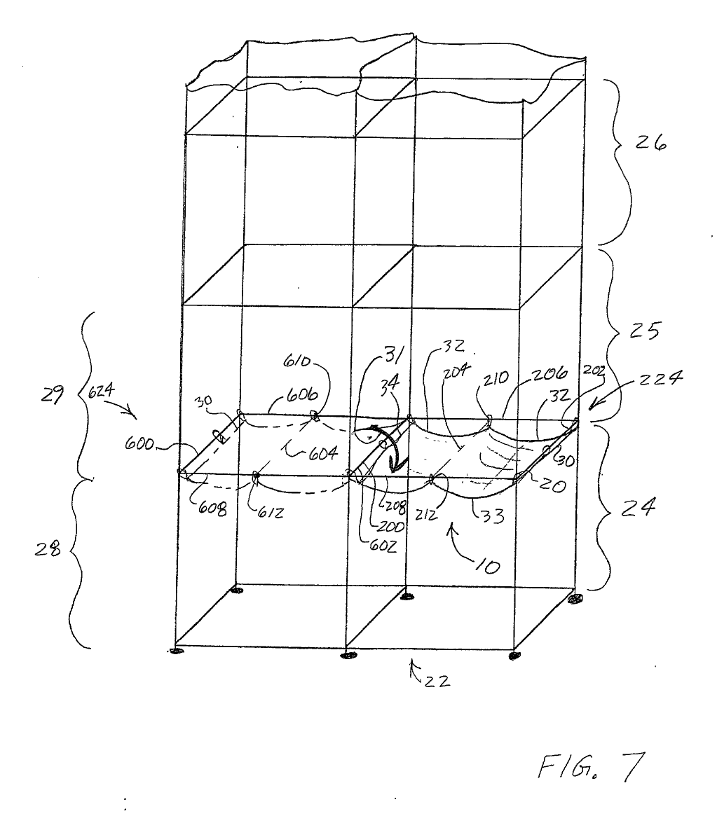

Referring to FIG. 7, the present invention contemplates not only vertically transposing scaffold safety net 10 between vertically adjacent scaffold module base peripheries, but also horizontally transposing scaffold safety net 10 between horizontally adjacent scaffold module base peripheries. As shown, scaffold structure 22 further comprises a fourth module 28 and a fifth module 29 which extend vertically with respect to each other. The numbering convention utilized to identify structural elements in second module 25 is likewise utilized to identify corresponding structural elements in fifth module 29. That is, second module 25 elements are identified as 2XX while fifth module 29 elements are identified as 6XX; with the exception of the most significant digits “2” and “6”, all corresponding structural elements for modules 25, 29 are otherwise identical. It is further shown that fifth module 29 and second module 25 are horizontally adjacent with respect to each other, and that lateral edge 200 of second module 25 is also a lateral edge 602 of fifth module 29. In other words, lateral edge 200, 602 is common to both modules 25, 29.

The sequence of moving scaffold safety net 10 from base periphery 224 of second module 25 to an adjacent horizontal periphery 624 of fifth module 29 shall now be discussed. To move scaffold safety net 10 from base periphery 224 to base periphery 624, connecting devices 20 connected to top side 30 are disconnected from lateral edge 202. Connecting devices 20 connected to first and second sides 32 and 33 are then disconnected from first and second adjacent edges 206 and 208 at first and second mid points 210 and 212, respectively. Because connecting devices 20 connected to bottom side 34 remain securely attached to common lateral edge 200, 602, scaffold safety net 10 may be pivoted about common lateral edge 200, 602, preferably in the direction indicated by rotation arrow 31, from base periphery 224 to base periphery 624. Once scaffold safety net 10 has been pivoted about common lateral edge 200, 602, connecting devices 20 connected to first side 30 are securely attached along a lateral edge 600 of base periphery 624. Connecting devices 20 connected to first and second sides 32 and 33 are then securely attached along first and second edges 606 and 608, respectively, at first and second mid points 610 and 612, thereby securing all connecting devices 20 of scaffold safety net 10 about base periphery 624 of fifth module 29.

The present invention further contemplates transposing scaffold safety net 10 between base peripheries of any horizontally adjacent modules sharing a common lateral edge. After disconnecting top side 30 and opposing first and second sides 32 and 33 from the base periphery of one of the horizontally adjacent modules, scaffold safety net 10 may then be pivoted about the common lateral edge of the horizontally adjacent modules because bottom side 34 remains securely attached to the common lateral edge. That is, scaffold safety net 10 may be pivoted about the common lateral edge from the base periphery of one of the horizontally adjacent modules to the base periphery of the other module. Once scaffold safety net 10 has been pivoted about the common lateral edge, opposing first and second sides 32 and 33 may be connected to the base periphery of the other adjacent module before connecting top side 30 to complete the connection of all sides of the scaffold safety net 10 to the base periphery of the other adjacent module. Alternatively, the order of disconnecting top side 30 and opposing first and second sides 32 and 33 may be reversed or combined. In other words, at least one connecting device 20 connected to either first or second sides 32 and 33 may be disconnected followed by disconnecting at least one connecting device 20 connected to bottom side 34. Similarly, the order of connecting top side 30 and opposing first and second sides 32 and 33 may be reversed or combined.

Alternately, mesh structure 13 may be defined by mesh members 14 and 16 which are not elongated. That is, instead of mesh members 14, 16 extending intact between corresponding sides of border member 12, mesh members 14, 16 may terminate at each interconnection therebetween. The pattern defining mesh structure 13 may represent any number of geometric shapes, such as a honeycomb pattern. Finally, mesh structure 13 of the present invention may be comprised of a single piece of material into which slits are introduced to form the desired mesh structure 13 pattern when the material is stretched. These slits may form apertures of many shapes including without limitation circular, elliptical, rectangular, rhombic, pentagonal, octagonal and polygonal so long as the aperture size as provided by industry or regulatory standards is not exceeded. Further, because both the pattern and shape of these apertures may widely vary, mesh structure 13 does not necessarily define a grid 18. Therefore, mesh structure 13 may include many possible configurations and any number of mesh members so long as the safety net operates as intended.

The invention further contemplates that border structure 11, which defines the outer periphery of scaffold safety net 10, may be comprised of multiple border members 12.

All components of scaffold safety net 10 are intended to be in compliance with industry regulatory standards, i.e., OSHA and American National Standards Institute (ANSI).

It is further contemplated that a plurality of safety nets 10 may be used, and that adjacent safety nets 10 may be assembled such that mid-span connecting devices 20, 420 may connect snap hooks 44, 440 to each other instead of looping around scaffold structure 22 which speeds installation/removal thereof without sacrificing workers' safety.

It should be understood from the foregoing that, while particular embodiments of the invention have been illustrated and described, various modifications can be made thereto without departing from the spirit and scope of the present invention. Therefore, it is not intended that the invention be limited by the specification; instead, the scope of the present invention is intended to be limited only by the appended claims.

What is claimed is:

1. A mobile safety net for use with multi-floor modular construction structure comprising:
a border structure defining a closed interior area;
a mesh structure bounded by said border structure, and
a plurality of connecting devices connected to the periphery of said border structure for securing the mobile safety net to the modular construction structure.

2. The mobile safety net according to claim 1 wherein said border structure is defined by a top side, a bottom side, and opposing first and second sides.

3. The mobile safety net according to claim 2 wherein said connecting devices are positioned at least along the corners of each said top, bottom, and opposing first and second sides, and along the mid-span of each of said top, bottom, and opposing first and second sides.

4. The mobile safety net according to claim 1 wherein said connecting device further comprises a flexible member having proximal and distal ends, said proximal end attaching to said border structure and said distal end attaching to an eyelet, a hook attachable to said border structure adjacent said proximal end for engaging said eyelet.

5. The mobile safety net according to claim 4 wherein said hook is a snap hook including a tongue for securing said hook in a closed position.

6. The mobile safety net according to claim 5 wherein said snap hook has an additional locking feature to secure said tongue in a closed position.

7. The mobile safety net according to claim 1 wherein said connecting device further comprises a flexible member having proximal and distal ends, said proximal end attaching to said border structure and said distal end attaching to a hook for engaging said modular construction structure.

8. The mobile safety net according to claim 7 wherein said hook is a snap hook including a tongue for securing said hook in a closed position.

9. The mobile safety net according to claim 8 wherein said snap hook has an additional locking feature to secure said tongue in a closed position.

10. A mobile safety net for use in multi-floor modular construction structure comprising:
an elongated border member defining a closed interior area having a top side, bottom side, and opposing first and second sides;
a mesh structure bounded by said elongated border member, said mesh structure having first and second elongated mesh members interconnecting at predetermined intervals, said first and second interconnecting mesh members defining a grid, and
a plurality of connecting devices connected to the periphery of said border member, said connecting devices located at least along the corners of each said top, bottom, and opposing first and second sides and along the mid-span of each said top, bottom, and opposing first and second sides for securing the mobile safety net to the modular construction structure.

11. A mobile safety net for use with multi-floor modular construction structure defining adjacently formed open box modules, each module having a plurality of lateral members interconnected at their respective ends collectively defining a base periphery, a plurality of lateral support members extending from and supported by each lateral member end, the lateral support members collectively supporting the base periphery of a vertically adjoining second module, comprising:
a border structure defining an enclosed area bounded by said border structure;
a mesh structure bounded by and supported by said border structure and substantially extending across said enclosed area;
a plurality of snap hooks securely attached to said border structure at points around the periphery of said border structure, said snap hooks being adapted to selectively and securely engage the lateral members to provide a fail-safe engagement therewith, said snap hooks being configured to engage the lateral members of the base periphery of the second module such that said mesh structure extends below said lateral members to substantially cover the area of the base periphery of the second module to prevent a person or other object from falling through the base periphery of the second module.

12. A method for mounting a mobile safety net to a modular construction structure, the mobile safety net having an elongated border member with a periphery defining a top side, bottom side, and opposing first and second sides; a mesh structure bounded by the elongated border member having first and second elongated mesh members interconnecting at predetermined intervals, the first and second interconnecting mesh members defining a grid; a plurality of connecting devices connected along the periphery of the elongated border member for securing the mobile safety net to the modular construction structure; the steps of the method comprising:
a) securing the connecting devices connected to the top side to a portion of the modular construction structure;
b) securing the connecting devices connected to the opposing first and second sides to another portion of the modular construction structure; and
c) securing the connecting devices connected to the bottom side to another portion of the modular construction structure.

13. A method for mounting a mobile safety net to a modular construction structure, the mobile safety net having an elongated border member with a periphery defining a top side, bottom side, and opposing first and second sides; a mesh structure bounded by the elongated border member having first and second elongated mesh members interconnecting at predetermined intervals, a plurality of connecting devices connected along the periphery of the elongated border member for securing the mobile safety net to the modular construction structure; the steps of the method comprising:
a) securing at least one connecting device connected to the top side to a portion of the modular construction structure;
b) securing at least one connecting device connected to the opposing first and second sides to another portion of the modular construction structure;
c) securing at least one connecting device connected to the bottom side to another portion of the modular construction structure; and
d) securing remaining connecting devices to another portion of the modular construction structure.

14. The method according to claim 13 wherein the sequence of said steps b) and c) are reversed.

15. A method of moving a mobile safety net for a modular construction structure having a first module with a first base periphery, and a second module with a second base periphery formed adjacent the first module, the mobile safety net having an elongated border member having a periphery defining an area bounded by a top side, a bottom side, and opposing first and second sides, a mesh structure bounded by the elongated border member having first and second elongated mesh members interconnecting at predetermined intervals, a plurality of connecting devices connected to the periphery of the border member for securing the mobile safety net to the first base periphery of the modular construction structure, the steps of the method comprising:
a) disconnecting the connecting devices connected to the top side from a portion of the first base periphery of the first module of the modular construction structure;
b) disconnecting the connecting devices connected to the opposing first and second sides from another portion of the first base periphery of the first module of the modular construction structure;
c) connecting at least one of the connecting devices connected to the top side to a portion of the second base periphery of the second module of the modular construction structure;
d) disconnecting the connecting devices connected to the bottom side from a portion of the first base periphery of the first module of the modular construction structure;
e) connecting at least one of the connecting devices connected to the opposing first and second sides to a portion of the second base periphery of the second module of the modular construction structure; and
f) connecting at least one of the connecting devices connected to the bottom side to a portion of the second base periphery of the second module of the modular construction structure.
g) securing remaining connecting devices to another portion of the second base periphery of the modular construction structure.

16. The method according to claim 15 wherein the sequence of said steps e) and f) may be reversed in order or combined.

17. The method according to claim 15 wherein the sequence of said step d) is performed before said step c) when the first and second sides are too short to perform said step c) before said step d.

18. The method according to claim 15 wherein the first module and second module are vertically adjacent.

19. The method of moving a mobile safety net for a modular construction structure having a first module with a first base periphery and a second module with a second base periphery formed horizontally adjacent the first module, the first base periphery and the second base periphery sharing a common lateral edge, the mobile safety net having an elongated border member having a periphery defining an area bounded by a top side, a bottom side, and opposing first and second sides, a mesh structure bounded by the elongated border member having first and second elongated mesh members interconnecting at predetermined intervals, a plurality of connecting devices connected to the periphery of the border member for securing the mobile safety net to the first base periphery of the modular construction structure, the steps of the method comprising:
a) disconnecting the connecting devices connected to the top side from a portion of the first base periphery of the first module of the modular construction structure;
b) disconnecting the connecting devices connected to the opposing first and second sides from another portion of the first base periphery of the first module of the modular construction structure;
c) connecting at least one of the connecting devices connected to the top side to a portion of the second base periphery of the second module of the modular construction structure;
d) connecting at least one of the connecting devices connected to the opposing first and second sides to a portion of the second base periphery of the second module of the modular construction structure; and
e) securing remaining connecting devices to another portion of the second base periphery of the modular construction structure.

20. The method according to claim 19 wherein the sequence of said steps a) and b) may be reversed in order or combined and said steps c) and d) may be reversed in order or combined.
